(19) United States
(12) Patent Application Publication
(10) Pub. No.: US 2022/0343406 A1
(43) Pub. Date: Oct. 27, 2022

(54) Exact-Frame-Fit technology using FD and PD to control try-on model image rendering at online eyeglasses e-commerce website and Web-development application

(71) Applicant: Yixian Gu, Totowa, NJ (US)

(72) Inventor: Yixian Gu, Totowa, NJ (US)

(21) Appl. No.: 17/238,397

(22) Filed: Apr. 23, 2021

(51) Int. Cl. G06Q 30/06

(52) U.S. Cl. CPC G06Q 30/0643

(57) ABSTRACT

This invention will utilize two dimensions on people's head: face dimension (FD) and pupillary distance (PD). FD is defined as measurement from left side face to right side face at the level of eyes. Pupillary-distance can be obtained from an eye doctor's examination.

Exact-frame-fit technology establishes precise relationships among FD, PD, and any eyeglasses that online shoppers want to buy. Therefore, customers can do try-on their selection on computer or mobile device when they do online shopping. If it looks good on computer or mobile device screen, it must be good on customer's actual face. It is WYSIWYG (what you see is what you get).

Online shoppers can measure FD by themselves. They can measure their own PD or get it from any eye doctor. After having these FD and PD data, they can visit exact-frame-fit enabled websites where they can input FD and PD data. The exact-frame-fit enabled websites will render model facial image according to these FD and PD inputs. Exact-frame-fit technology will establish precise relationship among FD, PD, and any eyeglasses that online shoppers want to buy. If it looks good and fit on computer or mobile device screen, it will be truly good in real. This exact-frame-fit technology will make online eyeglasses shopping much easier and accurate. This invention will allow online shoppers to do try-on for any eyeglasses frame much easily and precisely.

This invention will utilize two dimensions on people's head: face dimension (FD) and pupillary distance (PD). FD is defined as measurement from left side face to right side face at the level of eyes. Pupillary-distance can be obtained from an eye doctor's examination.

Exact-frame-fit technology establishes precise relationships among FD, PD, and any eyeglasses that online shoppers want to buy. Therefore, customers can do try-on their selection on computer or mobile device when they do online shopping. If it looks good on computer or mobile device screen, it must be good on customer's actual face. It is WYSIWYG (what you see is what you get).

Online shoppers can measure FD by themselves. They can measure their own PD or get it from any eye doctor. After having these FD and PD data, they can visit exact-frame-fit enabled websites where they can input FD and PD data. The exact-frame-fit enabled websites will render model facial image according to these FD and PD inputs. Exact-frame-fit technology will establish precise relationship among FD, PD, and any eyeglasses that online shoppers want to buy. If it looks good and fit on computer or mobile device screen, it will be truly good in real. This exact-frame-fit technology will make online eyeglasses shopping much easier and accurate. This invention will allow online shoppers to do try-on any eyeglasses frame much easily and precisely.

### BACKGROUND OF THE INVENTION

When people do online shopping to buy eyewear products such as eyeglasses, sunglasses, and reading glasses at e-commerce websites, online shoppers always face a difficult and unsolved problem. That is, they do not know if the eyeglasses they want to purchase really fits on the customer's face or not since they cannot do a physical try-on before they purchase the glasses. Some online merchandisers offer to ship a few pairs of eyeglasses to the online shopper for them to do try-on at their home. It is costly and takes time. This invention of exact-frame fit technology can solve this problem and enable online shoppers to do exact frame try-on during online shopping at exact-frame-fit enabled e-commerce websites.

### BRIEF DESCRIPTION OF THE DRAWINGS

FIG. 1: Typical head sketch.

FIG. 2: FD definition.

FIG. 3: PD definition.

FIG. 4: A typical pair of glasses.

FIG. 5: The glasses on model image rendering with FD-160 mm and PD-70 mm.

FIG. 6: The same glasses on model image rendering with FD-12 mm and PD-50 mm.

### DETAILED DESCRIPTION

When people do online shopping to purchase a pair of eyeglasses, they need to do try-on. It requires two images on a computer screen: a model image and a picture of eyeglasses frame. This invention of exact-frame-fit technology is to render model image in a precise methodology. Therefore; it creates a real relationship between images of model face and a pair of eyeglasses frame. If it looks good on computer screen, it must be good in real life.

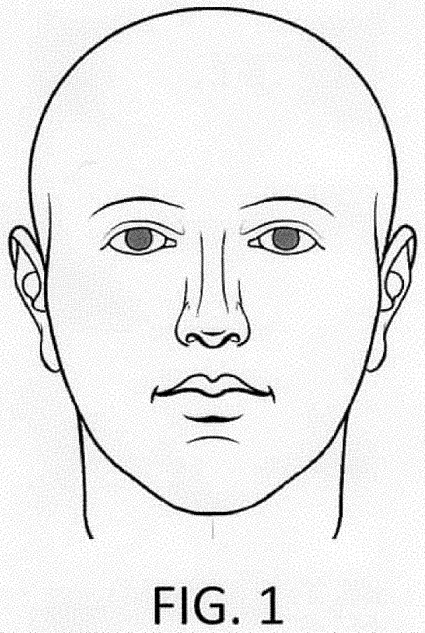

Exact-frame-fit technology utilizes two dimensions to render a model image: facial dimension and pupillary distance (abbreviated as FD and PD). FIG. 1 is a typical human head drawing used for the purpose of illustration of this exact-frame-fit technology.

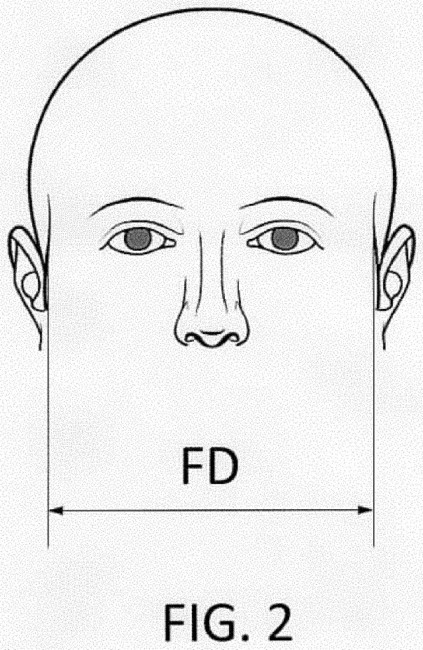

FD is facial dimension as shown in FIG. 2. It measures from left side temple to right side temple normally in the range from 120 mm to 160 mm. In computer rendering, each mm is represented by 3 pixels in exact size. Each pixel represents a dot on a computer screen.

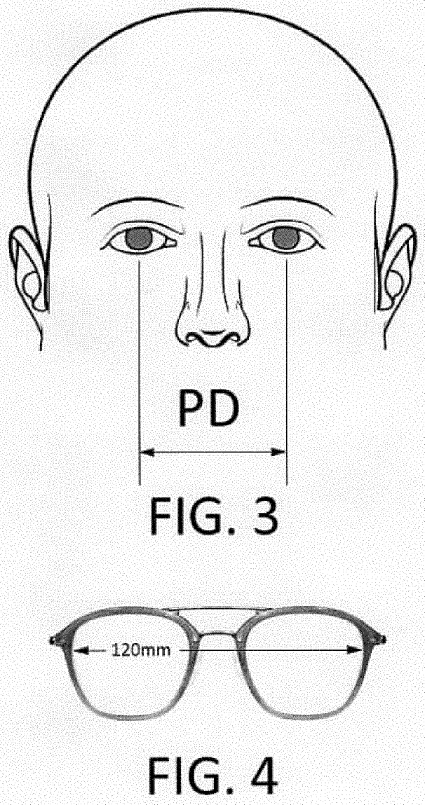

PD is pupillary distance between two eyeballs as shown in FIG. 3. PD can be obtained from eye doctors or from self-measurement.

Online shoppers shall know their FD and PD before do online shopping for eyeglasses. They can input their FD and PD to website data form. After receiving these FD and PD data, model image on the computer screen will be rendered according to these inputted FD and PD data. Therefore, if the try-on frame looks good on this digital try-on process, it must be truly good when online shoppers receive their purchase.

FIG. 4 shows a typical eyeglasses frame with 120 mm in size (360 pixels on computer or mobile device screen).

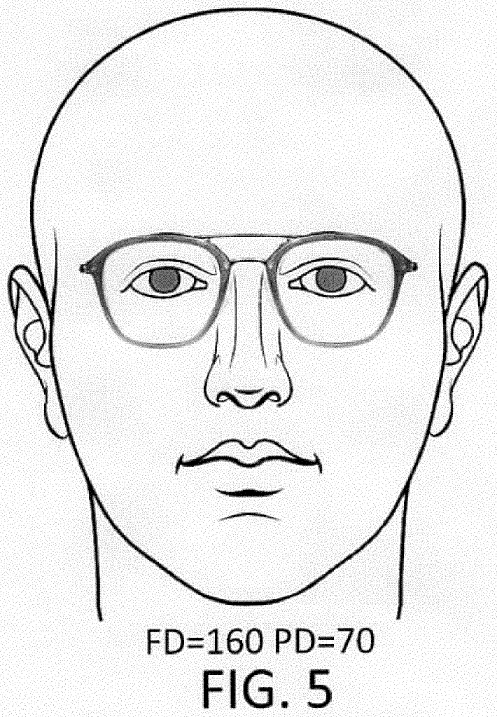

FIG. 5 displays a relatively large human head with 160 mm FD and 70 mm PD (480 and 210 pixels respectively). It can be observed that the frame is too small on this larger image rendering.

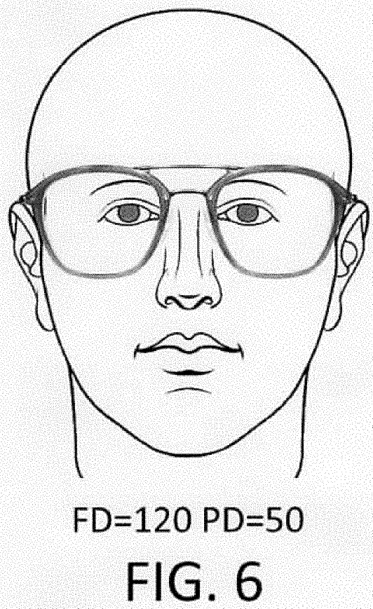

FIG. 6 shows a relatively small head with 120 mm FD and 50 nm PD (360 and 150 pixels respectively). It is obvious that the frame is too big for such small model rendering.

This exact-frame-fit technology establishes real and precise relationship between model facial image and eyeglasses frames. If it looks good and fit, it must be truly good and fit when online shoppers receive their purchase.

With implementation of this exact-frame-fit technology at a website, such as at www.eye7777.com, online shopping for eyeglasses become easy and pleasurable process.

1. A method of exact-frame-fit technology using FD and PD to control try-on model image rendering on computer or mobile devices and establish precise relationship between FD, PD, and try-on glasses, therefore; online shoppers can do realistic try-on with their glasses selections. With simple data input of their FD and PD, if the glasses look good on controlled model image rendering, it must be truly good when online shoppers receive their orders. Therefore, customers can receive WYSIWYG (what you see is what you get) eyeglasses via e-commerce online online shopping.
